(19) United States
(12) Patent Application Publication
(10) Pub. No.: US 2013/0225148 A1
(43) Pub. Date: Aug. 29, 2013

(54) TERMINAL WITH MODULE PROTECTION AND MODULE MANAGING METHOD

(71) Applicants: Jin Woo RYU, Seoul (KR); Sang Jun LEE, Seoul (KR); Mi Young HWANG, Seoul (KR)

(72) Inventors: Jin Woo RYU, Seoul (KR); Sang Jun LEE, Seoul (KR); Mi Young HWANG, Seoul (KR)

(73) Assignee: PANTECH CO., LTD., Seoul (KR)

(21) Appl. No.: 13/563,695

(22) Filed: Jul. 31, 2012

(30) Foreign Application Priority Data
Feb. 24, 2012 (KR) 10-2012-0019099

(51) Int. Cl. H04M 3/00

(52) U.S. Cl. 455/418

(57) ABSTRACT

The present disclosure relates to a terminal with a module protecting feature and a module managing method. The terminal includes: a module execution management section that collects and manages information to execute modules; a module installation and deletion management section that collects and manages information relating to installation or deletion of the modules; and a history management section that detects an association relationship between the modules on the basis of the information, which is received by the module execution management section and the module installation and deletion management section, and determines an associated module which may be affected at the time of module execution by deletion of a specific module when the specific module is deleted on the basis of the detected association relationship.

### CROSS-REFERENCE TO RELATED APPLICATION

This application claims priority from and the benefit of Korean Patent Application No. 10-2012-0019099, filed on Feb. 24, 2012, which is incorporated by reference for all purposes as if fully set forth herein

### BACKGROUND

1. Field

The following description relates to a terminal with module protection, and a module managing method.

2. Discussion of the Background

There has been an increase in the demand to delete specific applications and modules of terminals, such as smart phones, tablet computers, personal computers, etc., in order to improve the terminal, for example, in order to increase a storage space of the terminal or improve a speed of the terminal. Generally, each module is a unit which is obtained when a program is functionally divided, that is, each module is defined as each of small portions into which a program is divided so as to internally execute one united action. The module may be an upper ordinate concept including the application, and the module is a concept including not only the application but also software and the like, which are used as references at the time of driving the application. For example, in an Android® platform, applications, services, referential packages, and the like may be formed as Android Package (APK) units, and may be included in the concept of the module.

An act for obtaining the authority of the administrator in an operating system of an Android® phone is called ‘rooting’, and this word is derived from the term indicating an act for obtaining the authority of the administrator in the Linux. In other words, Android® uses Linux as an operating system, and the account having the highest authority in Linux is ‘root’. By changing a user authority of the Android® operating system to a ‘super user’ through the rooting, a function, which is not supported by the Android® operating system, may be added, and a supported function may be deleted.

The applications which are installed in advance when the terminal is released, i.e., preload applications, may be set not to be deleted even if a user wants to delete them from the terminal. Accordingly, in order for a user to delete a preload application, it may be necessary to acquire an administrator authority. Acquiring the administrator authority is called ‘rooting’ as described above. Many users delete, modify, or add the applications in the terminal through the use of rooting.

However, if a user accesses, modifies, or deletes applications and modules of an operating system of the terminal, the user may not be able to use some important modules and applications which the user wants to use. In addition, the accessing, modifying, or deleting of applications and modules may result in a situation where even basic booting of the terminal is not possible.

It is not easy for general users to make a determination as to the risks of accessing, modifying, or deleting of applications and modules. Temporal costs and physical costs may be incurred if the errors occur in accessing, modifying, or deleting of applications and modules which may lead to restoring a terminal to an original state to correct the errors.

### SUMMARY

Exemplary embodiments of the present invention provide a terminal which determines the potential consequences from the deletion of a module.

Exemplary embodiments of present invention also provide a method of managing the deletion of modules or application to provide potential consequences of the deletion.

Additional features of the invention will be set forth in the description which follows, and in part will be apparent from the description, or may be learned by practice of the invention.

An exemplary embodiment of the present invention discloses a terminal, including: a module execution management section configured to collect and manage execution information to execute modules; a module installation management section configured to collect and manage installation information relating to installation of the modules; a history management section configured to detect an association relationship between the modules according to the execution information and the installation information, and to determine an associated module having an association relationship with a first module, the association relationship being a relationship in which the associated module is affected by deletion of the first module; and a user interface configured to display the associated module which may be affected by the deletion of the first module.

An exemplary embodiment of the present invention also discloses a method for managing the deletion of a first module, including: collecting execution information about a plurality of modules; determining an association relationship between the plurality of modules according to the execution information; if a deletion request is received for the first module, displaying associated modules according to the association relationship.

An exemplary embodiment of the present invention also discloses a method for deleting a first application in a terminal, including: receiving a request to delete the first application in the terminal; generating an associated application list of associated applications related to the first application from a history table; determining if the first application has a replaceable relationship with regards to the associated applications; determining if the first application has a deletable relationship with regards to the associated applications; displaying the associated application list in which the determined replaceable relationship and deletable relationship are identified.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a flowchart illustrating a method for installing and deleting an application in a Windows® platform according to the related art.

FIG. 2 is a flowchart illustrating a method for checking a static element of an Android® platform according to the related art.

FIG. 3 is a diagram of a terminal according to an exemplary embodiment of the present invention.

FIG. 4 is a diagram of a terminal according to an exemplary embodiment of the present invention.

FIG. 5 is a flowchart of a method for recording history information according to an exemplary embodiment of the present invention.

FIG. 6 is a flowchart of a method for deleting an application of a terminal according to an exemplary embodiment of the present invention.

FIG. 7 is a flowchart of a method for checking a replaceable application of the terminal according to an exemplary embodiment of the present invention.

FIG. 8 is a flowchart of a history UI component section of the terminal according to an exemplary embodiment of the present invention.

FIG. 9 is a diagram illustrating a user interface according to an exemplary embodiment of the present invention.

FIG. 10 is a diagram illustrating a user interface according to an exemplary embodiment of the present invention.

FIG. 11 is a diagram illustrating a user interface according to an exemplary embodiment of the present invention.

### DETAILED DESCRIPTION OF THE ILLUSTRATED EMBODIMENTS

Exemplary embodiments are described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

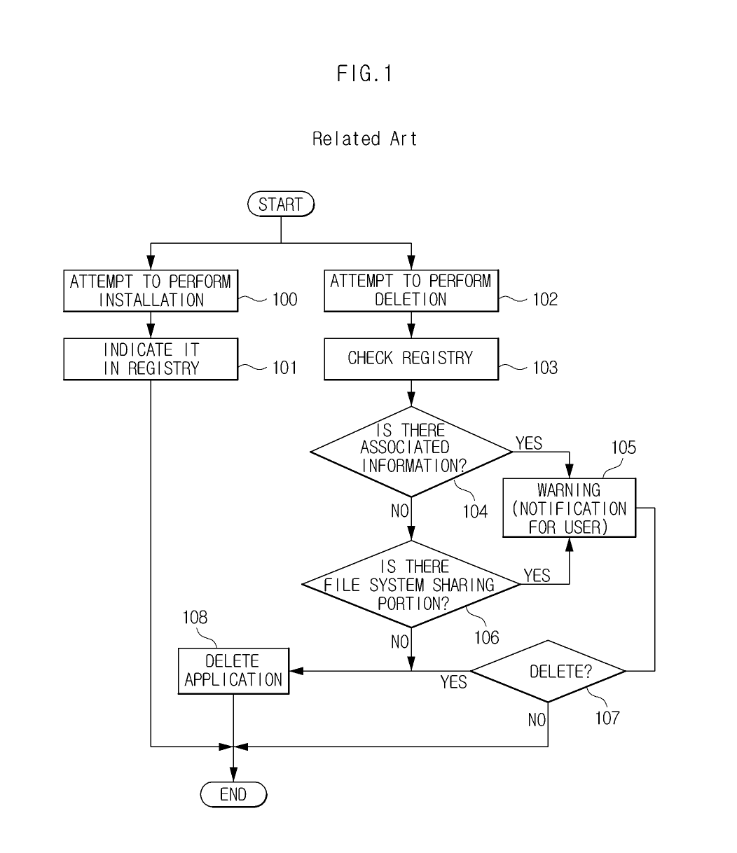

FIG. 1 is a flowchart illustrating a method for installing and deleting an application in a Windows® platform according to the related art. The Windows® platform includes a system capable of performing the following operations of: if installing applications (i.e., components), recording all pieces of information which are installed in the registry and completing the installation thereof; and if deleting a system or libraries and application programs registered in a device, checking the registry to determine if information relating to the registry exists or if a sharing portion of the file system exists and displaying this information for a user.

Referring to FIG. 1, in operation 100, an attempt to install an application is made. In operation 101, related information associated with the application is indicated in a registry. In operation 102, an attempt to delete the application is made. In operation 103, the recorded registry is checked. In operation 104, it is determined if the related information exists. In operation 105, if the related information exists, a warning message is transferred to a user. If there is no related information, in operation 106 it is additionally determined if the file system sharing portion exists.

If the file system sharing portion exists, the method returns to operation 105, and a warning message is generated and transferred to the user. In operation 108, if the file system sharing portion does not exist, the application is deleted. If the warning message is provided to the user in operation 105, in operation 107, the deletion is confirmed through a confirmation popup window. If the user confirms the deletion, the method proceeds to operation 108 and the application is deleted. If the deletion of the application is not confirmed in operation 107, the deletion method ends.

In the Linux® operating system, deletion or execution is restricted by an authority of the Linux® operating system. The Linux® operating system has a self-security format in which the authority is divided into root, group, and user and each corresponding part is managed only by its authority. Accordingly, deletion is possible if the corresponding authority is obtained through rooting. In the Android® platform, applications are installed in units of Android® Packages (APKs), and the applications are executed through “intent.” APKs are independent modules, but different modules may be executed through intent. In the security architecture of the Android® operating system permission may be requested to install an application. The user-permission is used to install an application. This permission may not be provided when the application is executed, but may be statically provided at the time of installation.

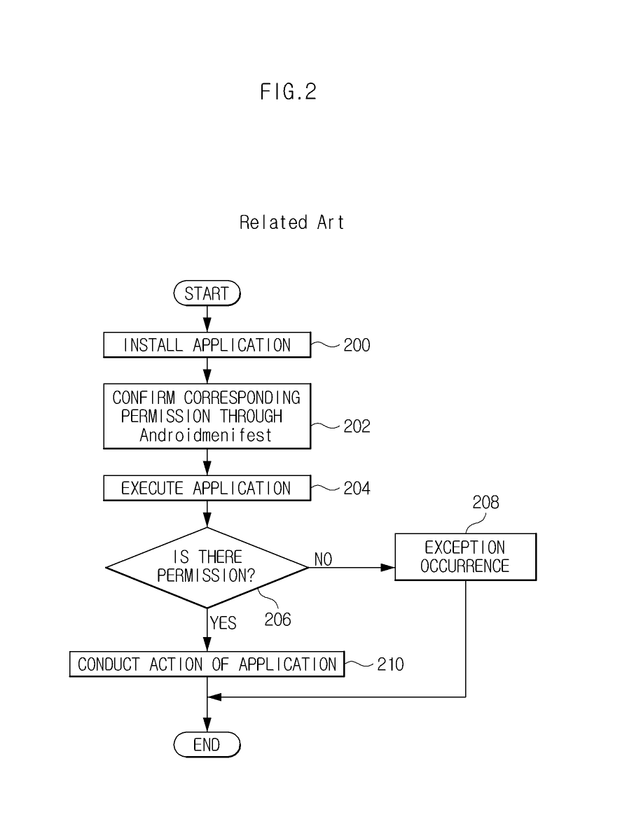

FIG. 2 is a flowchart illustrating a method for checking a static element of an Android® platform according to the related art.

FIG. 2 is a flowchart in which a static element is detected at the time of installation and a determination as to whether the static element exists in a preset state is made at the time of execution. In other words, if an application is installation in a state where the permission to install the application is confirmed at the time of installation, if the permission is executed, it is determined whether or not the permission exists. If there is no permission, the corresponding program may cause an exception and may be terminated.

Referring to FIG. 2, in operation 200, the application is installed. In operation 202, the corresponding permission is confirmed through Androidmenifest. In operation 204, the application is executed. In operation 206, it is determined whether permission exists to execute the application. If permission exists, in operation 210 the application is executed. If permission does not exist, in operation 208, an exception occurs and execution is ends.

There are various tools available to developers to recognize the relativity or relationship between applications (or components), such as, eclipse, apt-get, and the like. In Eclipse for Rich Client Platform (RCP) (i.e., a version of the eclipse for developing RCP), in order to develop one program, a module may be divided into multiple plug-ins, and the plug-ins may be managed. In order for each plug-in to operate, the developer may record dependent plug-ins, and in order to use the developed plug-in in a different plug-in, the plug-in may be derived so as to be able to include parents of the plug-in. The apt-get of the Linux® operating system includes and installs a module dependent upon a downloaded module. A developer, who distributes the module, may explicitly write the relativity with a specific module.

In the Windows® operating system, it is not difficult to reinstall built-in files to the terminal, and thus only a warning message is generated if an application to be deleted could impact other applications. In the Android® operating system there may be a static security policy, such as permission, but the permission may be restrictively used in practice. Accordingly, if such permission is provided at the time of execution, similar to other architectures, a portion for management may be separately formed, and the corresponding portion may be managed. The permission may also be used differently.

In order to form an association relationship between modules, in the related art, explicit indications of the relationship between applications are needed from the developer of the application. For example, when A application utilizes B application, the B application has to be recorded in a step of developing the A application. In a case of an application distributed in advance, for example B application, it is difficult to know the relationship of these applications with other applications before an update by the developer thereof and the developer has to write the relationship with reference to a common specification.

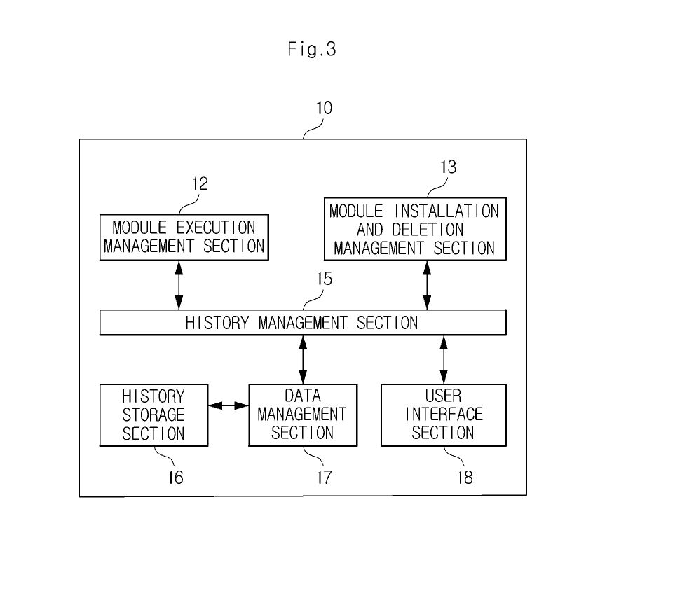

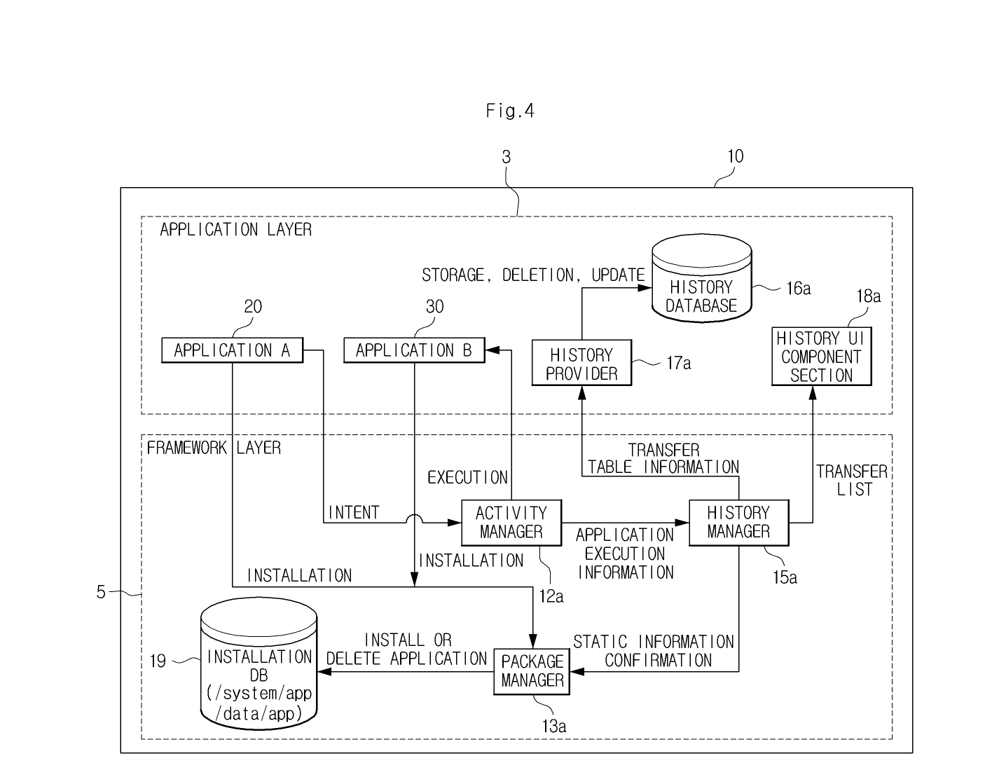

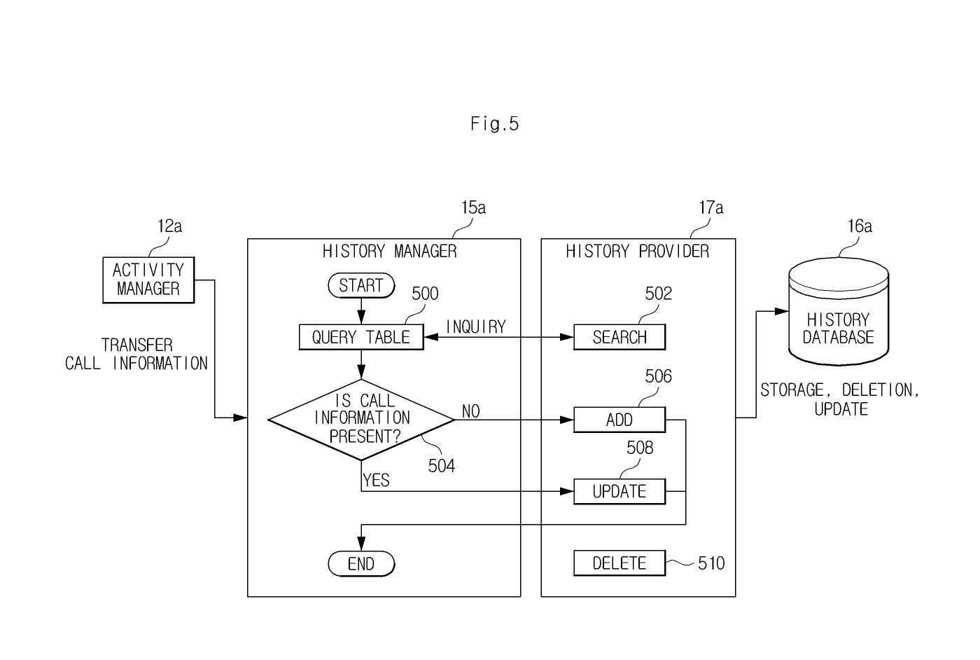

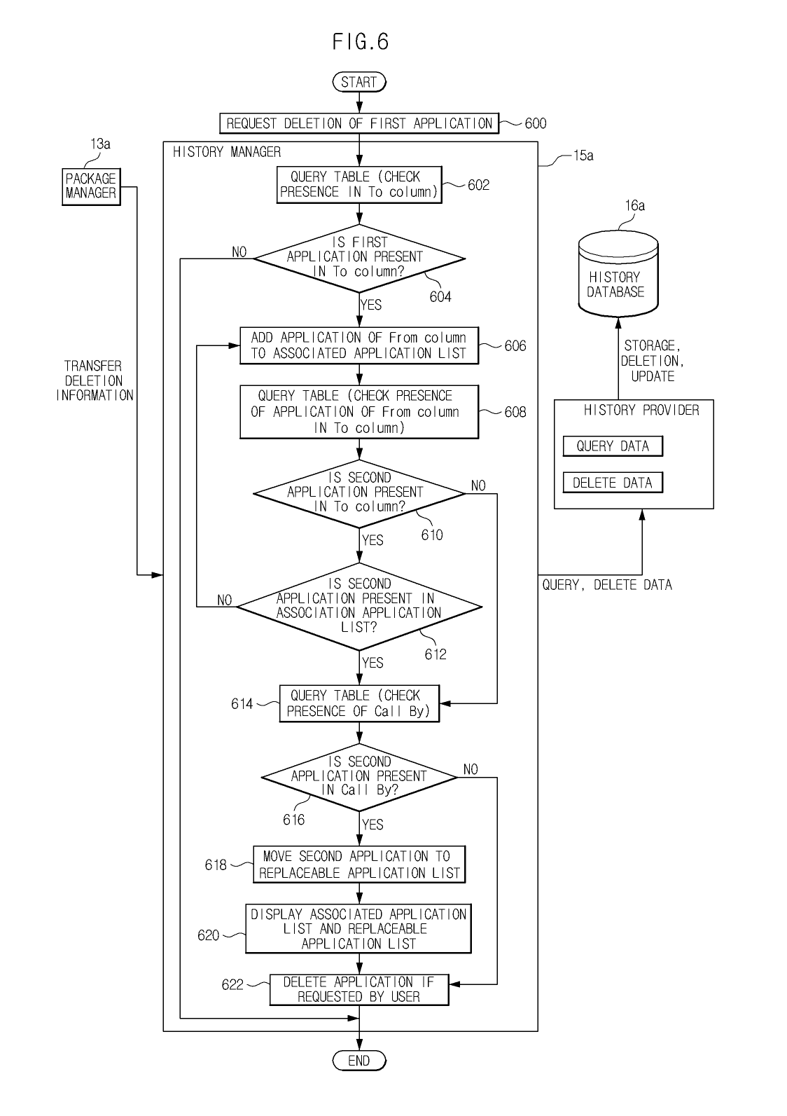

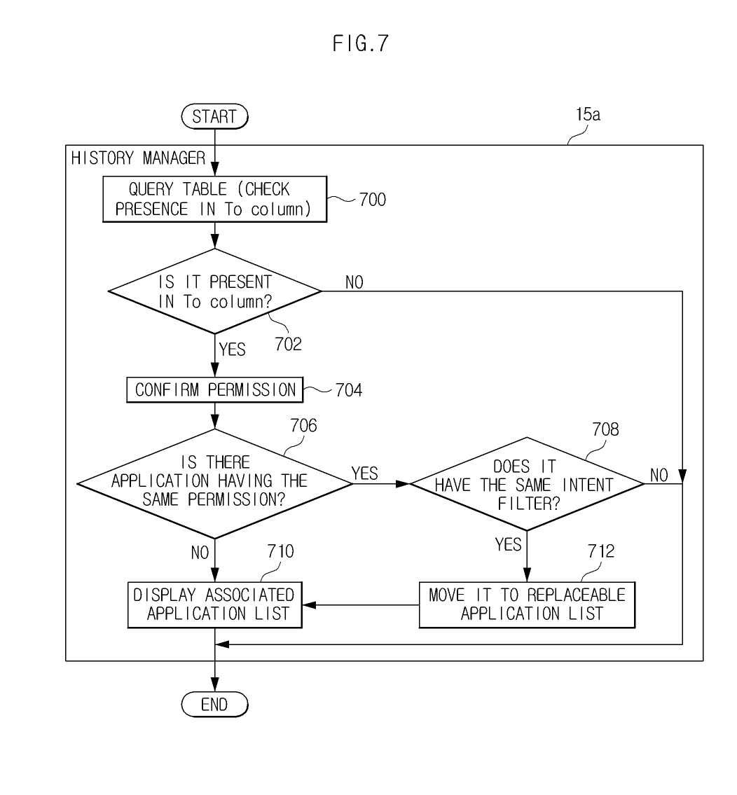

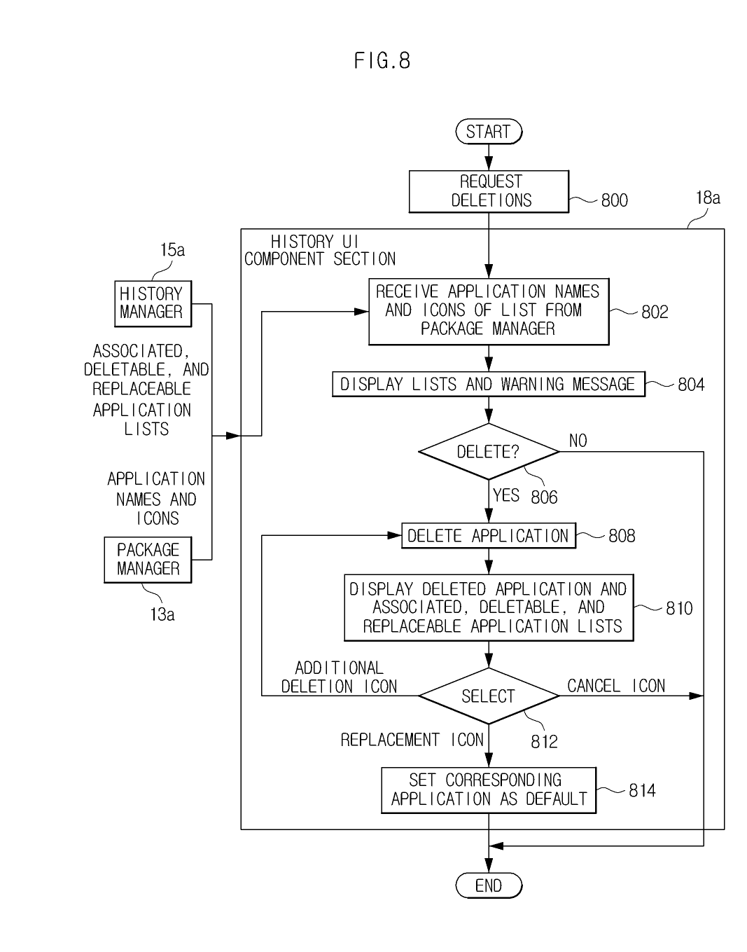

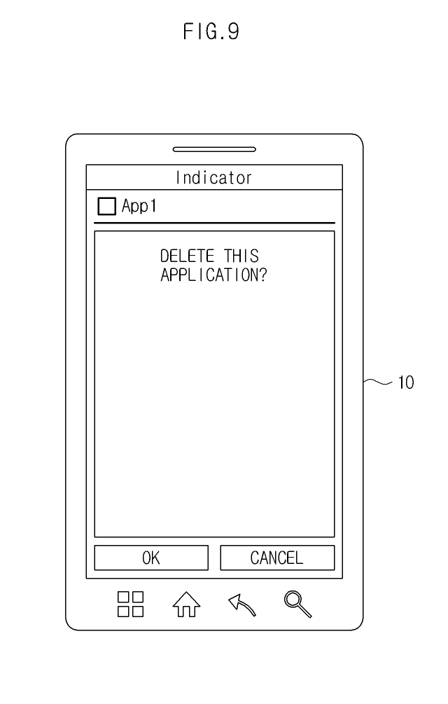

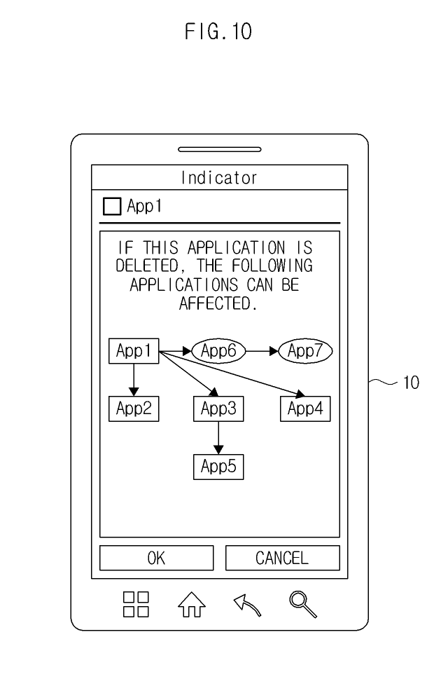

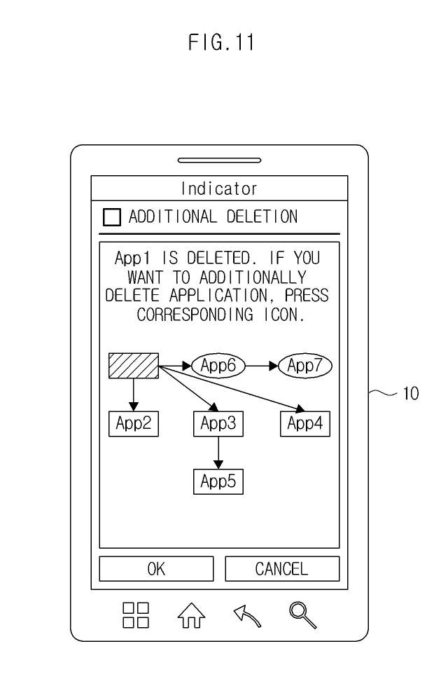

Referring to FIG. 3, FIG. 4, FIG. 5, FIG. 6, FIG. 7, FIG. 8, FIG. 9, FIG. 10, and FIG. 11, a terminal and an application management method using the terminal will be described in detail. The following description will focus on a terminal with the Android® platform or operating system. However, the invention is not limited thereto and the present disclosure may be applied to the other platforms such as the Windows® platform, the Linux® platform, and the iOS® platform of Apple Corporation.

The term “module” refers to a concept including not only an application but also services and packages which may be used as references at the time of driving the application. The following description will focus on the case where a user deletes an application, for convenience of description, but is not limited thereto.

FIG. 3 is a diagram of a terminal according to an exemplary embodiment of the present invention.

Referring to FIG. 3, the terminal 10 includes a module execution management section 12, a module installation and deletion management section 13, a history management section 15, a history storage section 16, a data management section 17, and a user interface section 18.

The module execution management section 12 may be configured to collect and manage information for executing modules in the terminal 10. The module installation and deletion management section 13 may be configured to collect and manage information relating to installation or deletion of modules in the terminal 10. The module installation and deletion management section 13 may be configured as two separate sections a module installation management section and a module deletion management section.

The history management section 15 may be configured to detect an association relationship between modules on the basis of information which is received from the module execution management section 12 and the module installation and deletion management section 13. If a specific module is deleted on the basis of the detected association relationship, the history management section 15 may be configured to determine an associated module which may be affected by the deletion of an application, component, module, etc.

The term “association relationship” refers to a call relationship between modules at the time of execution of each module. In other words, if an application is executed through one of the modules, in response to a call command, a different application may be executed, or it may be possible to refer to information received from the different application, and thus the relationship represents a relationship based on the call command. For example, if an X application is executed, a Y application may be called. If the called Y application is deleted, an error may occur if the X application is executed.

In other words, an associated module may be a module that may cause an error at the time of executing the associated module if a first module is deleted.

The history management section 15 may be configured to determine a deletable relationship between associated modules and a replaceable relationship between associated modules. A replaceable relationship may be determined if a module exists that may be called in replacement of another module. A deletable relationship may be determined based on whether a deletable module exists in the associated modules. The deletable module may be deleted if there is a replaceable module that may be called in replacement of the first module requested to be deleted. In other words, if the call command requests an action, there may be multiple modules to execute the action. In this case, it can be said that there may be replaceable modules. Replaceable modules will be described in greater detail below.

The history storage section 16 is configured to store the detected association relationship. The data management section 17 is configured to store, delete, or update data in the history storage section 16 in response to a command from the history management section 15.

The user interface section 18 is configured to display at least one of a list of the associated modules, a list of the deletable modules, and a list of the replaceable modules in response to a command of the history management section 15.

In other words, the terminal may build databases of information pieces accumulated at the time of installing modules, deleting modules, and executing modules, and may detect the association relationship between the modules from the information in the built database, detect an associated module which may be affected at the time of deleting a first module on the basis of the detected association relationship, and warns a user on the basis of the detected associated module.

Hereinafter, a method for performing such actions in a terminal employing Android® platform will be described with reference to FIG. 4.

FIG. 4 is a diagram of a terminal according to an exemplary embodiment of the present invention. The terminal 10 of FIG. 4 may employ the Android® platform. A principal configuration of the Android® platform will be described as follows.

The Android® platform may be operated through an asynchronous message mechanism which is known as ‘intent’. The intent activates Activity, Service, and Broadcast Receiver which may be principal components of an Android® application. The intent may contain an abstract description of actions to be performed, and applications may be executed on the basis of the information of the intent.

Components may refer to applications, modules, and combinations thereof that may be executed in a terminal. ‘Component Name’ refers to the name of each component. The component may be formed by combining the name of the component and the Class Name of a class. If the component name is designated and the intent information is sent, the component may be transferred to the designated class, and may be executed.

The Activity is one of the components constituting the Android® application, and may be generally defined as one screen. A single application may have various screens, and thus the single application may have various activities. The Service is one of the Android® components which has no screen and is executed in the background. The Broadcast Receiver represents a receiver which receives messages (such as a battery state and the like) relating to the status of the system or messages of applications.

The “Action” is a string indicating an action to be executed, and may be configured to activate a specific action through a reference constant. For example, “ACTION_CALL” may indicate that a phone call is made, and “ACTION-EDIT” may indicate that data to be edited is displayed to a user.

The “Category” represents a string having information on types of additional components for intent control. For example, “CATEGORY_HOME” may represent that the activity is used as a home screen, and “CATEGORY_PREFERENCE” may indicate that the activity is the setting panel.

The “Data” may indicate the uniform resource identifier (URI) of the data to be processed and the Multipurpose Internet Mail Extensions (MIME) type of the data. For example, if there is an action of “ACTION_Edit,” the URI of the document to be displayed for editing may be included, and in the case of “ACTION_CALL”, the number for making a phone call and the like such as “tel:URI” may be included.

The “Intent Filter” refers to the proccessability of the component, it may be a set of intents which the component intends to receive. This is described in the ‘AndroidManifest.xml’. The items which may be subjected to filtering are Action, Category, and Data.

The “Action Filter” refers to a test of actions in the intent so as to test whether actions match with the actions defined in the filter. In order to pass the test, the action in the intent should match with the action defined in the intent filter. However, if the action is not defined in the intent, it may pass the action filter. Table 1 illustrates an exemplary result of an Action Filter.

TABLE 1

| Action Defined in Intent | Action Defined in Intent Filter | Result |
|---|---|---|
| Intent.ACTION_VIEW | Android.intent.action.VIEW | Pass |
| Intent.ACTION_VIEW | Android.intent.action.EDIT | Reject |
| None | Any Action Does Not Matter | Pass |

The “Category Filter” refers to a test of items in the intent so as to test whether the items match with the categories defined in the filter. Contrary to the Action Filter where the test may be passed if the action is not defined in the intent, if the category is not defined in the intent, it is rejected in the Category Filter. If a category is not added at the time of generation of an implicit intent, CATEGORY_DEFAULT (Android.intent.category.DEFAULT) may be automatically added. In order to receive the intent which does not add the category, CATEGORY_DEFAULT may be added to the category filter. Table 2 illustrates an exemplary result of a Category Filter.

TABLE 2

| Category of Intent | Category of Intent Filter | Result |
|---|---|---|
| Intent.CATEGORY_DEFAULT | None | Reject |
| Intent.CATEGORY_DEFAULT | Android.intent.category.DEFAULT | Pass |

The “Data Filter” refers to a test of the data and type in the intent. The data test may be classified into a portion, which tests the address (e.g., URI) of the data, and a portion which tests the type or the MIME type of the data. The portion, which tests the address of the data, is configured to segment the address of the data and conduct the test. A URI may be constructed with the following structure “scheme://host:port/path”.

For example, if “http://google.com” is divided into respective elements, the ‘scheme’ is http, and the ‘host’ is google.com. In order to filter the type of the data, the type (MIME type) is used. Normally, the definition of the MIME type is as follows.

<data Android:mimeType=“video/mpeg” Android:scheme=“http”>
<data Android:mimeType=“audio/*” Android:scheme=“http”>

The mimeType may be defined by the above-mentioned format, and may be defined in the format of “large class/lower class of large class” (for example, in the case of video/mpeg, the large class is the video, and the lower class is the mpeg). By using a wildcard character (*) for the lower class, all formats within the corresponding class may be allowed.

Thus, a first <data> filter may allow the intent, which has “the video data of the mpeg format having the http scheme,” and the second filter may allow the intent which has “all audio data having the http scheme.”

The action of the intent filter is described with reference to the following exemplary source code.

```
<activity Android:name=“NotesList” Android:label=“@string/
title_notes_list”>
  <intent-filter>
    <action Android:name=“Android.intent.action.MAIN” />
    <category Android:name=“Android.intent.category.LAUNCHER” />
  </intent-filter>
<intent-filter>
    <action Android:name=“Android.intent.action.VIEW” />
    <action Android:name=“Android.intent.action.EDIT” />
    <action Android:name=“Android.intent.action.PICK” />
    <category Android:name=“Android.intent.category.DEFAULT” />
    <data
    Android:mimeType=“vnd.Android.cursor.dir/vnd.google.note” />
  </intent-filter>
</activity>
```

With reference to the above source code, the first intent filter is constituted of “ACTION_MAIN (Android.intent.action.MAIN)” as an action which indicates that the corresponding activity may be set as a starting point of the application, and “CATEGORY_LAUNCHER (Android.intent.category.LAUNCHER)” as a category which is for allowing the activity to be displayed in the application launcher. In other words, the activity is displayed in the application launcher and the activity may be set as the starting point of the application including the activity.

The second intent filter may be conditions used if the activity is called through an implicit intent. The second intent filter indicates that it is possible to receive an intent object having one action of “ACTION_VIEW,” “ACTION_EDIT,” and “ACTION_PICK,” and having “vnd.Android.cursor.dir/vnd.google.not” as its type. The second intent filter may define “CATEGORY_DEFARULT” in order to receive the implicit intent.

The explicit intent and implicit intent are described in greater detail below. The explicit intent refers to an intent which declares the target component and designates the target on the basis of the name of the target components. Since it may be difficult for a developer of another application to know such a name of the component, the explicit intent is typically used if the additional service, the application, or the equivalent activity of itself is executed. The explicit intent is transferred to the target which is constantly designated regardless of the intent filter.

In contrast, the implicit intent refers to an intent which does not separately designate the name of the target. Accordingly, the designated intent may be managed by the intent filter described above, and may be used to activate another application.

If a specific intent is intended to be transferred, the target component has to be able to receive such intent regardless of the state thereof. The activity manager service and the package manager service may be able to conduct such an action.

The package manager determines, at the time of installation, which intent each component intends to receive and which static element each component includes, and conducts management like a single address book. The activity manager receives the intent, finds a reception target component on the basis of the address book stored in the package manager, and conducts an appropriate action in accordance with a state of the target component which has to receive the intent. In other words, the activity manager integrally manages life-cycles of the activities.

The two services may be Android® system services, and the services may be loaded at the time of starting the Android® platform and may continuously reside in the system.

The activity manager may be described as follows. APIs, which are used in order for the Android® application components to transfer the intents, are roughly classified into startActivity, startService, and sendBroadcast. If such APIs are called, the APIs finally called are present in the activity manager service. In other words, all the intents occurring on the Android® platform may be transferred to the activity manager service. If the activity manager service receives the intent, the target of the corresponding intent may be determined through the package manager service, and the intent may be transferred to the target. The activity manager service has such a relaying function, and thus it may be possible to know all the states of the component, and it may be possible to integrally manage the life-cycles of the activities.

If the terminal is executed first, the package manager may search the APK installation path (for example, /system/app or /data/app) in the Android® platform, perform passing on the Androidmanifest.xml file of the corresponding file in the installed APK file, and collect all of various authority information and authority information determined in the APK such as intent filter, thereby conducting management in the memory. The package manager may receive the broadcast intent which is generated if an application is newly added or deleted, and may update or delete the address book managed by the manager.

In the exemplary embodiments, the information on installation and deletion of applications and the information on execution thereof are collected, and the association relationship between the applications are derived on the basis of the collected information. Thereby, it may be possible to determine an application, which may be affected by deletion of a specific application, on the basis of the association relationship between the applications. In the case of the terminal employing the Android® platform, the activity manager and the package manager may collect the information.

Referring to FIG. 4, in the Android® system, as described above, an application may be executed through the intent, and the related information may be transferred to another component. Therefore, if the action of the intent is monitored and the history is accumulated and managed, the actions of all applications installed in the terminal may be detected, and the relationships among applications may be detected.

An intent mechanism may be managed by an activity manager and a package manager among the platform services. In addition, the intent mechanism can, through the intent, know information and time as to which application in the activity manager sends the intent when the application is started through the intent, and which application is executed as the target thereof.

As shown in FIG. 4, the terminal 10 includes an activity manager 12a which is a component of a first administrator module 12 of FIG. 3, a package manager 13a which is a component of a second administrator module 13 of FIG. 3, and a history manager 15a which is a component of the history manager module 15 of FIG. 3.

As shown in FIG. 4, the activity manager 12a and the history manager 15a, are located in the framework layer. The history manager 15a may receive information from the package manager 13a. History information of the association relationship between applications may be stored on the basis of the intent information, and by using the intent information an application list of applications which may be affected by application deletion may be generated and provided to a user, and the user may thereby be warned of the risk of deleting an application. Thereby, it may be possible to reduce the risk of a critical problem occurring from the deletion.

A history database 16a, a history provider 17a, and a history user interface (UI) component section 18a may be controlled by the history manager 15a and may be located in the application layer. The components respectively correspond to a history storage module 16, a data management module 17, and a user interface module 18 of FIG. 3. The history database 16a may be a component corresponding to the history storage section 16 of FIG. 3. The history provider 17a may be a component corresponding to the data management section 17 of FIG. 3. The history UI component section 18a may be a component corresponding to the user interface section 18 of FIG. 3.

Referring to FIG. 4, the overall action is described as follows.

If an application, such as, application A 20 and/or application B 30 is installed or deleted, the package manager 13a may be configured to collect and manage information relating to the installation and the deletion. If the terminal 10 is executed, the package manager 13a may search an installation database (DB) 19 via the APK installation path (for example “/system/app” or “/data/app”) in the Android® platform. The package manager 13a may pass on the Androidmanifest.xml file of the corresponding file in the installed APK file, and may collect various authority information and authority information determined in the APK, such as, intent filter and may thereby conduct management in the memory. The package manager 13a may receive the broadcast intent which may be generated if a new application is added or an existing application is deleted, and updates or deletes the address book managed by the manager.

The activity manager 12a may be configured to receive the intent from each application and transfer the intent to the target through the intent filter so as to execute the application. The activity manager 12a may be configured to collect and manage the intent information. FIG. 4 illustrates that the application A 20 transfers intent information to the application B 30 as a target application and the activity manager receives the intent information from the application A 20 and transfers the intent information to the application B 30 to execute the application B 30.

The history manager 15a may be configured to receive information about execution of the applications and information about installation and deletion of applications from the activity manager 12a and the package manager 13a, and to determine on the basis of the information. If a user makes a request for deletion of a specific application, the history manager 15a queries the installation information which may be stored in the installation DB 19 through the package manager 13a, thereby checking static information (that is, information written in the Androidmanifest.xml, information belonging to an application of the APK unit such as the authority information and the intent filter information). The history manager 15a may query the application execution information through the activity manager 12a, and may correct, add, delete, or updates a database on the basis of the information or transfer a list thereof to the history UI component section 18a.

The history database 16a may be configured to store information on the association relationship between applications in a table form on the basis of the intent information which may be transferred from the history manager 15a. The history provider 17a may be configured to manage the history database 16a. The history provider 17a may be configured to generate a history table, and to interpolate, delete, or update the information in the history database 16a. The history provider 17a may be controlled by a command of the history manager 15a, and if the corresponding information is queried, the history provider 17a may read the information from the history database 16a, and may transfer the information to the history manager 15a. The history provider 17a may have a structure of a general contents provider, may be positioned in the application layer, and may manage the corresponding data base.

The history table information may be used to generate a database and may be stored in a data format described below.
1. “To” is information of an application which is called, i.e., executed
2. “From” is information of an application which makes the call, i.e., performs the execution
3. “Count” is the frequency of the call
4. “Time” is the time at which the call is made
5. “Call By” is storage of the corresponding information when the call is an implicit call

The application which is called or makes the call and the “Count” and “Time” information for the application may be stored together. If only the time is stored, if a user executes various applications at a specific time for a test, the application, which is frequently used (i.e., which may be important to the user), may have a lower priority and thus may not be provided to a user. If only the “Count” is stored, an application which is frequently used by the user but may not have been used recently may have a high priority. The intent of the Android® platform is able to implicitly make a call without designating a specific application, and thus the “Call By” field may be included in the table in order to statically manage the intent.

The history UI component section 18a may be located in the application layer in a package form. The history UI component section 18a constitutes a UI which may be determined by a user at the time of deletion. The user checks the current list through such a UI, and may be able to perform deletion, replacement, addition, and the like of applications. In other words, the history UI component section 18a may be configured to generate an overall screen configuration for the terminal 10. The specific action will be described together with an example.

FIG. 5 is a flowchart of the method for recording history information according to an exemplary embodiment of the present invention.

If the specific application transfers the intent information, after the activity manager 12a receives and analyzes the information, if there is call information of another application, the manager transfers the call information to the history manager 15a. In operation 500, the history manager 15a queries the history table and transfers the inquiry to the history provider 17a. In operation 502, the history provider 17a searches databases of the history database 16a.

In operation 504, the history manager 15a determines whether the “TO COLUMN” and “FROM COLUMN” of the call information are present in the history database 16a according to the search in operation 502. In operation 508, if it is determined that the “TO COLUMN” and “FROM COLUMN” are present in the database, the history manager 15a compares the “TO COLUMN” and “FROM COLUMN” with the information in the database and may update the information. In operation 508, if the “TO COLUMN” and “FROM COLUMN” are not in the history database 16a, the history manager 15a adds the “TO COLUMN” and “FROM COLUMN” to the database. In operation 510, if information is updated or data corrected, the existing data is deleted. The “TO COLUMN” and “FROM COLUMN” will be described in greater detail below.

FIG. 6 is a flowchart of a method for deleting an application of a terminal according to an exemplary embodiment of the present invention.

In operation 600, a user requests deletion of a first application in the terminal 10 and the package manager 13a transfers information relating to the deletion to the history manager 15a. In operation 602, the history manager 15a checks whether the first application to be deleted is present in the “TO COLUMN” of the history table through the history provider 16a. In operation 604, if it is determined that the first application to be deleted is present in the “TO COLUMN,” in operation 606, the history manager 15a adds a second application in the “FROM COLUMN” to the associated application list. The ‘associated application’ refers to an application that may cause an error at the time of execution due, if the first application is deleted.

In operation 608, it is determined whether the second application added from the “FROM COLUMN” is present in the “TO COLUMN.” In operation 610, it is determined if the second application added from the “FROM COLUMN” is present in the “TO COLUMN.” In operation 612, the history manager 15a determines whether a third application, corresponding to the “FROM COLUMN” of the second application, is present in the associated application list. If it is determined that the associated application is not in the associated application list, the history manager 15a returns to operation 606.

If the third application is present in the associated application list, in operation 614, the history manager 15a queries the history table, and determines whether the “Call By” field is present for the second application, and the third application. If the “Call By” field is present in operation 616, in operation 618, the history manager 15a may move or copy the corresponding application to a replaceable application list. In operation 620, the replaceable application list is provided to a user. The replaceable application list may be provided to a user by displaying the replaceable application list on a user interface. In operation 622, if the user requests deletion of the first application, the history manager 15a deletes the first application in the history table through the history provider 17a.

The method described above is described in greater detail with reference to the following exemplary table.

TABLE 3

| To | From | Count | Time | Call By |
|---|---|---|---|---|
| App X | App Y | 2 | 23:11 | |
| | App Z | 1 | 22:01 | |
| | App L | 1 | 16:23 | |
| App A | App B | 3 | 11:00 | Browser |
| | App C | 2 | 23:12 | |
| | App D | 2 | 15:21 | Browser |
| App C | App I | 4 | 07:12 | Message |
| | App J | 2 | 15:11 | |
| App J | App O | 1 | 13:11 | |

The types of the call lists in the above Table 3 are described as follows.

1. Providing Simple Call List

Referring to Table 3, if the App X is deleted, the associated applications provided by the associated application list, which may be affected by the deletion of App X, are the “App L, App Z, and App Y.” The applications “App L, App Z, and App Y” called the App X in the past, and thus if the App X is deleted, the “App L, App Z, or App Y” may call the App X later, and a problem may arise if the App X is deleted.

2. Providing List of Chain Structure

Referring to Table 3, if the App C is deleted, the associated application list affected by the deletion is the “App I, App J, and App O.” Although the App O is not in the “FROM COLUMN” of App C, the App J was called by the App O, and thus the App O is also affected by the deletion of App C.

3. List Provided at Deletion of Application Receiving Implicit Call

Referring to Table 3, if the App A is deleted, the associated application list is the “App B, App C, App D, App I, App J, and App O.” The App I, App J, and App O belong to a chain structure list of the App C and may therefore be affected by the deletion of App A. “Browser” indicates the presence of a replaceable application which may be used to replace an application. Table 3 indicates replaceable applications may be called instead of the App A for the App B and the App D, which executes the App A through the implicit call for a “Browser” request, may be constituted as a deletable application list which may be deleted. It is possible to detect whether the replaceable application is present in Table 3 by searching for “Browser.” Applications which may be included in a deletable application list may be removed from the associated application list. The ‘deletable application list’ refers to a list of applications. The applications in the deletable application list may be applications which may be subjected to a call for a specific action that may be performed by another application. In other words, applications in the “deletable application list” may be deleted and another application may be subjected to the call so as to be able to perform the corresponding action of the deleted application. For example, if a first application calls a second application if the first application calls for a “Browser” action, the second application may be deleted if there are other applications which perform the “Browser” action. By providing the associated application list and the deletable application list to a user with, for example, mutually distinctive icons, a user may determine whether or not to perform deletion.

FIG. 7 is a flowchart of a method for checking the replaceable application of the terminal according to an exemplary embodiment of the present invention.

If a first application is to be deleted, in operation 700, the history manager 15a queries the history table to check if the first application is included in the “TO COLUMN.” In operation 702, the history manager 15a determines whether the first application is present in the “TO COLUMN.” If the first application is present in the “TO COLUMN,” in operation 704, the history manager 15a confirms a permission of the first application. In operation 706, the history manager 15a determines whether an application having the same permission is present in the terminal 10.

If an application having the same permission is absent, in operation 710, the corresponding application is determined to not be a replaceable application. In operation 710, the terminal displays the associated application list of the first application.

If an application having the same permission is present, in operation 708, it is determined whether the application has the same intent filter as the first application. If it is determined that the application has the same intent filter, in operation 712, the first application is determined to be a replaceable application and is thus moved or copied to the deletable application list. The deletable application list is displayed with the associated application list in operation 710.

FIG. 8 is a flowchart of a history UI component section of the terminal according to an exemplary embodiment of the present invention.

In operation 800, a user requests application deletion. In operation 802, the history UI component section 18a receives the associated application list, deletable application list and replaceable application list from the history manager 15a, and receives the application names and the icon information from the package manager 13a.

In operation 804, the history UI component section 18a displays the associated application list, deletable application list, and replaceable application list and a warning message to the user through a display section (not shown in the drawing). In operation 806, a popup window confirming whether to continue the deletion in spite of the warning message in the display section is displayed. If the deletion is confirmed in operation 806, in operation 808, the history UI component section 18a deletes the application. In operation 810, the history UI component section 18a displays the deleted application, the associated application list, and replaceable application list. If the deletable application list is provided as a specific message or icon to the user, whether or not to delete the deletable application list depends on selection of the user.

In operation 812, the associated application list, the replaceable application, and/or the deletable application list are provided to a user to select an application to deleted. If the user selects an additional deletion icon to delete an additional application, the method returns to operation 808 and the selected application is deleted. If the user selects a cancel icon, the method is terminated. If the user selects a replacement icon, in operation 814, a selected application is set as a default application of the corresponding intent. The ‘replacement icon’ refers to an icon for replaceable application list which may be used to select an application as a substitute application to perform the function of a corresponding application.

FIG. 9 is a diagram illustrating a user interface according to an exemplary embodiment of the present invention. FIG. 10 is a diagram illustrating a user interface according to an exemplary embodiment of the present invention. FIG. 11 is a diagram illustrating a user interface according to an exemplary embodiment of the present invention.

A user is able to enter a user interface capable of deleting an application in the terminal 10. Referring to FIG. 9, the user who entered the user interface is able to enter a mode for deleting the application App 1. In FIG. 9, if the user presses the confirmation button “OK” the association application list of the application App 1 and a warning message, are displayed, as shown in FIG. 10.

In FIG. 10, the applications App 2, App 3, App 4, and App 5 belong to the associated application list, and are displayed as rectangular icons which may indicate that there is no replaceable application. In contrast, the applications App 6 and App 7 are displayed as oval icons. The applications App 6 and App 7 may represent the deletable applications which belong to the associated application list but may be replaced with replaceable applications.

If such a warning message is displayed, the user may be able to recognize that the applications App 2, App 3, App 4, and App 5 may cause errors if the application App 1 is deleted, and thus the user may be able to determine whether or not to delete the application App 1. If the user presses the confirmation button “OK,” the icon of the application App 1 is deleted, and is displayed as a hatched rectangle, and a the message asking whether to perform additional deletions is displayed, as shown in FIG. 11. If the user selects a specific application icon, the selected icon may be also deleted.

If the replaceable application App 6 or App 7 is pressed, a UI may display the replaceable applications, which may be replaced before or after deletion of the corresponding application, and may allow a user to set a replaceable application as a default application for the corresponding function. The replaceable application may be displayed as an icon together with the corresponding application.

According to the exemplar embodiments, it may be possible to provide a method of accumulating and managing the information about the installation and the deletion of applications and the information about the execution of applications to warn a user about causing an error which may occur due to rooting and the like.

According to the exemplary embodiments, by using a method of accumulating information in accordance with a usage history in which a user executes and uses applications in the terminal, a method for detecting an association relationship between applications, which are not developed on the basis of an explicit indication by a developer of a relationship, may be provided.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A terminal, comprising:
a module execution management section configured to collect and manage execution information to execute modules;
a module installation management section configured to collect and manage installation information relating to installation of the modules;
a history management section configured to detect an association relationship between the modules according to the execution information and the installation information, and to determine an associated module having an association relationship with a first module, the association relationship being a relationship in which the associated module is affected by deletion of the first module; and
a user interface configured to display the associated module which may be affected by the deletion of the first module.

2. The terminal of claim 1, wherein the history management section is configured to determine a replaceable relationship between the first module and the associated module according to the execution information and the installation information, and the user interface is configured to display the replaceable relationship.

3. The terminal of claim 1, wherein the history management section is configured to determine a deletable relationship between the first module and the associated module according to the execution information and the installation information, and the user interface is configured to display the deletable relationship.

4. The terminal of claim 1, wherein the history management section is configured to detect an association relationship between the modules according to an explicit intent of the modules and an implicit intent of the modules.

5. The terminal of claim 1, wherein the user interface is configured to display a request to delete the associated module if the first module is deleted.

6. The terminal of claim 2, wherein the history management section is configured to determine a replaceable relationship between the first module and the associated module according to the execution information and the installation information by determining a permission of the first module and an intent of the first module, determining if a second module has the same permission as the first module, and determining if the second module has the same intent as the first module.

7. The terminal of claim 3, wherein the history management section is configured to determine a deletable relationship between the first module and the associated module according to the execution information and the installation information by determining an action of the first module; determining if other modules perform the action of the first module, and determining if a second module does not explicitly call the first module.

8. A method for managing the deletion of a first module, comprising:
collecting execution information about a plurality of modules;
determining an association relationship between the modules of the plurality of modules according to the execution information;
if a deletion request is received for the first module, displaying associated modules according to the association relationship.

9. The method of claim 8, further comprising:
determining a replaceable relationship between the first module and the plurality of modules according to the execution information; and
displaying the replaceable relationship.

10. The method of claim 9, wherein a replaceable relationship between the first module and the plurality of modules comprises:
determining a permission of the first module and an intent of the first module;
determining if a second module of the plurality of modules has the same permission as the first module; and
determining if the second module has the same intent as the first module.

11. The method of claim 8, further comprising:
determining a deletable relationship between the first module and the plurality of modules according to the execution information; and
displaying the deletable relationship.

12. The method of claim 8, further comprising:
if the first module is deleted, displaying a request to delete a third module if the association relationship between the first application and the third module exists.

13. A method for deleting a first application in a terminal, comprising:
receiving a request to delete the first application in the terminal;
generating an associated application list of associated applications related to the first application from a history table;
determining if the first application has a replaceable relationship with regards to the associated applications;
determining if the first application has a deletable relationship with regards to the associated applications;
displaying the associated application list in which the determined replaceable relationship and deletable relationship are identified.

14. The method of claim 13, wherein generating an associated application list of associated applications related to the first application from the history table, comprises:
determining if the first application is included in the history table;
determining a first associated application which explicitly calls the first application;
determining a second associated applications which implicitly calls the first application; and
generating associated application list comprising the first associated application and the second associated application.

15. The method of claim 13, wherein the history table comprises a list of applications executed in the terminal, a list of applications called by each application, a count of the number of times an application has called another application, a duration of the call by each application to another application, and a type of each call by of each application.

16. The method of claim 13, further comprising generating the history table, wherein generating the history table comprises:
receiving call information including a calling application and a called application;
determining if the calling application and the called application are stored in a history database;
if the calling application and the called application are stored in the history database, updating the history database according to the call information; and
if the calling application and the called application are not stored in the history database, adding the call information to the history database.

17. The method of claim 13, further comprising:
displaying a request for deletion of associated applications if the first application is deleted; and
displaying a request for selection of a replacement application if a replaceable relationship exists with regards to the associated applications.

18. The method of claim 13, determining if the first application has a replaceable relationship with regards to the associated applications comprises:
determining a permission of the first application and an intent of the first application;
determining if a second application has the same permission as the first application; and
determining if the second application has the same intent as the first application.

19. The method of claim 13, wherein determining if the first application has a deletable relationship with regards to the associated applications comprises:
determining an action of the first application;
determining if other application perform the action of the first application;
determining if a second application does not explicitly call the first application.
